(19) United States
(12) Patent Application Publication
(10) Pub. No.: US 2005/0258267 A1
(43) Pub. Date: Nov. 24, 2005

(54) Wave generation device and method of operation

(76) Inventor: Courtney J. Potter, Perth (AU)

Correspondence Address: LAMORTE & ASSOCIATES P.C., P.O. BOX 434, YARDLEY, PA, 19067, US

(21) Appl. No.: 11/026,987

(22) Filed: Jan. 3, 2005

(30) Foreign Application Priority Data
May 19, 2004 (AU) 200490644

(51) Int. Cl. E03B 9/20; B05B 17/08; F21S 8/00; E03C 1/08

(52) U.S. Cl. 239/16; 239/17; 239/18

(57) ABSTRACT

A tabletop display device that displays a continuously breaking wave of water. The device has a water reservoir that holds a small volume of water. A contoured surface is provided. The contoured surface is concave between the bottom end and the top end. A pump is used to produce a stream of water. The stream of water is directed against the bottom of the contoured surface. The stream of water is directed upwardly and curls over by the concave shape of the contoured surface. The flow of water then falls back from the elevated position, therein creating a continuously breaking wave. A figure is provided that floats on the stream of water and appears to be riding the breaking wave.

### RELATED APPLICATION

This application claims the priority of Provisional Australian Patent Application No. 2004902644, entitled Wave Generator Device, which was filed May 19, 2004.

### BACKGROUND OF THE INVENTION

1. Field of the Invention

In general, the present invention relates to tabletop fountain devices where water is constantly recycled through a display landscape by an electric pump.

2. Background Art

Novelty desktop fountain displays have been present in the market for many years. Such fountain displays typically have an electric pump that pumps water to the top of some type of landscape display. The water carried by the pump is then allowed to flow down the face of the landscape display and into a collection basin. The pump feeds from the collection basin, therein continually recycling the water. Such prior art novelty fountains are exemplified by U.S. Pat. No. 6,279,835 to Hansen, entitled, Fountain Having Background Surface For Displaying Liquid Running Thereover; and U.S. Pat. No. 6,450,122 to Frank, entitled, Decorative Water Display Including A Low Maintenance Aquatic Animal Basin.

However, in such prior art display fountains, the flow of water over a display landscape is design solely for aesthetics. The flowing water is intended to create a visually pleasant display with accompanying pleasant audible sounds of running water. Rarely, is the flow of the running water used for any secondary purpose.

The present invention device pumps water against a contoured surface that is engineered to produce a reproduction of a breaking ocean wave. Although the flow of the water is aesthetically pleasing, that is not the primary purpose of the water flow. Rather, the water flow is used to cause movement in a secondary object, such as a ship or a surfer, that appears to be riding along the reproduction of the breaking ocean wave. The details of the present invention device and its method of operation are described and claimed below.

### SUMMARY OF THE INVENTION

The present invention is a tabletop display device that displays a continuously breaking wave of water. The device has a water reservoir that holds a small volume of water. A contoured surface is provided. The contoured surface has a bottom and a top, wherein the contoured surface is concave between the bottom and the top. A pump is used to produce a stream of water. The stream of water is directed against the bottom of the contoured surface. The stream of water is directed upwardly and curled over by the concave shape of the contoured surface. The flow of water then falls back from the elevated position. Thus, the stream of water produces a continuously breaking wave that endures for as long as the stream of water endures.

A figure is provided that floats in position within the stream of water. The figure is connected to the contoured surface so it cannot be washed away by the stream of water. However, the figure can move within a predetermined range so that it is free to float upon the stream of water. Thus, a display is produced of a continuously breaking wave having a figure, such as a surfer, that is riding the continuously breaking wave.

### BRIEF DESCRIPTION OF THE DRAWINGS

The present invention will now be described, by way of example, with reference to the accompanying drawings, in which:

FIG. 1 is a perspective view of a wave generator device in accordance with the present invention; and

FIG. 2 is a perspective view of the wave generator device of FIG. 1 in use.

### DETAILED DESCRIPTION OF THE DRAWINGS

Although the present invention display device can have many configurations, it will be understood that the configuration used in the illustrations is merely exemplary.

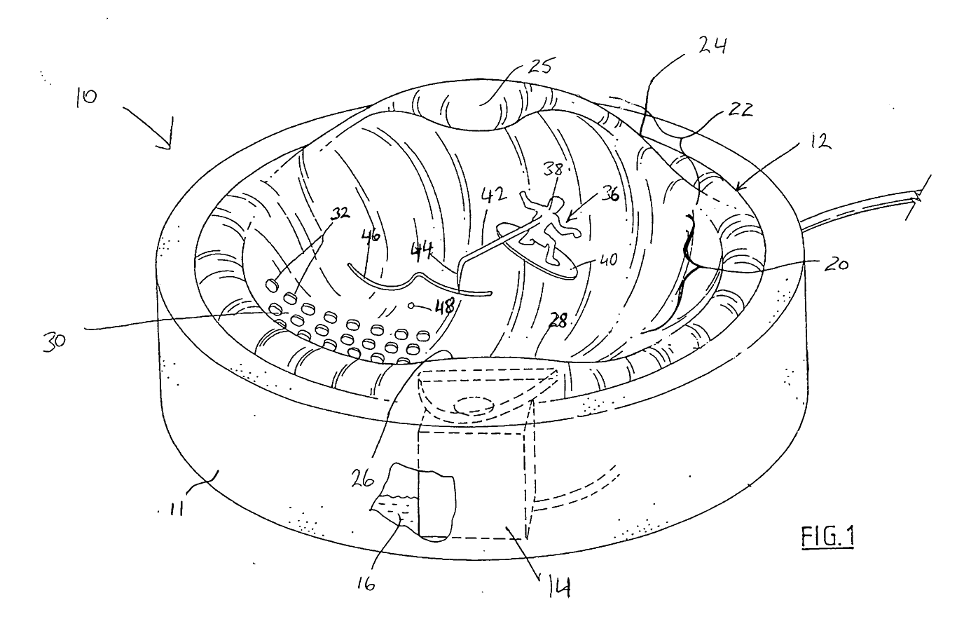

Referring to FIG. 1, the display device 10 is being shown empty of water. The display device 10 has a base 11 that supports a contoured surface 12 upon a flat support, such as a tabletop. Although the base 11 is shown as circular, it will be understood that the base can have many alternate shapes.

A fluid reservoir 16 is present within the confines of the base 11, under the contoured surface 12. The fluid reservoir 16 holds a small volume of water.

A pump 14 is provided that communicates with the fluid reservoir 16. The pump 14 can be any known type of commercially available pump used for pumping relatively small volumes of water. The pump 14 can be either battery powered, or directly powered by an AC plug 15, such as is shown.

The contoured surface 12 is comprised of a relatively bowl-shaped portion 20 and a wave-shaped portion 22. The bowl-shaped portion 20 has a front edge 26 and a rear edge 24. The wave-shaped portion 22 is a concave structure that extends up vertically near the rear edge 24 of the bowl-shaped portion 20. The wave-shaped portion 22 tapers toward its apex, forming a hooked overhang 25 at the apex.

A drain 30 is present in the bowl-shaped portion 20. In the shown embodiment, the drain 30 is comprised of a plurality of holes 32 such that water present upon the contoured surface 12 will drain through the holes 32 into the fluid reservoir 16. However, it will be understood that a slot, or even a single drain hole can be used in place of the plurality of holes 32.

The pump 14 draws water from the reservoir 16. The pump 14 has an elongated output nozzle 28. The elongated output nozzle 28 faces the wave-shaped portion 22 of the contoured surface 12. In this manner, any water exiting the pump 14 will be directed toward the center wave-shaped portion 22 of the contoured surface 12.

The display device 10 is also provided with a display FIG. 36. The display FIG. 36 in the embodiment shown is configured as a person 38 standing on a surfboard 40. Alternate variations of the display FIG. 36 can include a sailboat, a mermaid, a swimmer or the like. The display FIG. 36 is provided with a support arm 42. The support arm 42 extends from the body of the person 38 generally parallel to the surface of the surfboard 40 and includes a downwardly extending portion 44 at its distal end.

The downwardly extending portion 44 has an end which passes into a groove 46 in the contoured surface 12. The extending portion 44 is constrained within the groove 46, in use, but can reciprocally slide along the length of the groove 46. Preferably the end of the support arm 42 is weighted to assist in retaining the extending portion 44 of the support arm 42 in groove 46.

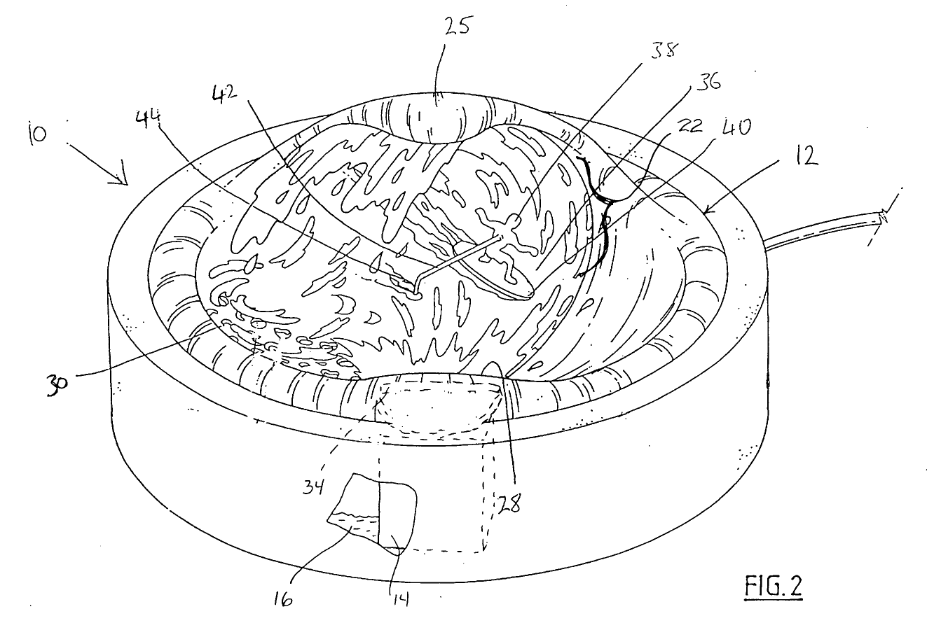

Referring now to FIG. 2, it can be seen that when water is added to the display device 10, the water partially fills the reservoir 16 and is drawn by the pump 14. As the pump 14 expels the water out the elongated nozzle 34, a flat, wide stream of water is propelled toward the wave-shaped portion 22 of the contoured surface 12. This arrangement allows sufficient coverage of the wave-shaped portion 22 of the contoured surface 12 to create the desired wave-like appearance while requiring a minimum volume of water to be flowing. This, in turn, allows the use of a small, inexpensive low volume pump 14 to be used in the wave generator device 10.

The stream of water flows, in use, up the wave-shaped portion 22 and along the concave surface until the stream of water curls under the apex and forms a breaking wave. The water falls back into the bowl-shaped portion 20, where it returns to the fluid reservoir 16 via the drain 30.

In use, the display FIG. 36 is placed on the contoured surface 12 adjacent the wave-shaped portion 22, in a position in which a surfboard rider would generally be found riding a wave. The support arm 42 extends generally away from the wave-shaped portion 22.

The display FIG. 36 is constructed such that when the water is flowing, the display FIG. 36 is lifted from the contoured surface 12 and floats on the surface of the water. The display FIG. 36 can move as the downwardly extending portion 44 of the support arm 42 slides along the groove 46. The shape and position of the groove 46 is designed such that the display FIG. 36 moves through a range of positions in which a rider of the wave would be expected to move. The display FIG. 36 may move under the action of the flow of water against the display FIG. 36 or the support arm 42, or by external force, such as by an observer blowing toward the display FIG. 36.

The contoured surface 12 may also be provided with one or more indentations 48 (FIG. 1) in which the downwardly extending portion 44 of the support arm 42 may be placed. This would result in the display FIG. 36 being constrained generally to one position relative to the wave with only minor movement caused by the surface of the water and pivoting about the indentation 48.

Alternatively, the support arm 42 may be permanently attached to the surface 12 and made of a flexible material such that the movement of the display FIG. 36 results from bending of the flexible support arm 42.

It will be understood that a person skilled in the art could make many changes to the present invention by changing the dimensions and/or positions of the various components. All such modifications and variations are intended to be included within the scope of the present invention as defined by the claims.

1. A display device, comprising:
a water reservoir;
a contoured surface;
a pump for pumping a stream of water from said reservoir across said contoured surface; and
a figure that floats upon said stream of water, wherein said figure is connected to said contoured surface and constrained from moving beyond a predetermined range.

2. The device according to claim 1, wherein said contoured surface includes a vertically extending concave section, wherein said stream of water is directed toward said vertically extending concave section, therein causing said steam of water to form a breaking wave.

3. The device according to claim 2, wherein said figure is disposed on said vertically extending concave section.

4. The device according to claim 1, wherein said pump has an elongated and flat exit nozzle from which said steam of water emanates, therein causing said stream of water to be wide and flat as it flows across said contoured surface.

5. The device according to claim 1, further including a groove formed in said contoured surface, wherein said figure is coupled to said contoured surface by an element that engages said groove and moves freely along said groove.

6. The device according to claim 1, wherein said contoured surface is disposed above said reservoir and drain holes are formed in said contoured surface to enable said stream of water to flow into said reservoir.

7. A device for creating a simulation of a breaking wave, said device comprising:
a reservoir for holding a volume of water;
a contoured surface having a bottom and a top, wherein said contoured surface is concave between said bottom and said top, and wherein said top of said contoured surface is higher than said bottom; and
a pump for pumping a stream of water from said reservoir to said contoured surface, wherein said stream of water is received at said bottom of said contoured surface in a first direction and continues to said top of said contoured surface where it exits in a second direction, forming a breaking wave.

8. The device according to claim 7, further including a figure positioned within said stream of water that can be moved through a predetermined range by said stream of water.

9. The device according to claim 8, wherein said figure floats upon said stream of water.

10. The device according to claim 7, wherein said pump has an elongated and flat exit nozzle from which said steam of water emanates, therein causing said stream of water to be wide and flat as it flows across said contoured surface.

11. The device according to claim 7, further including a groove formed in said contoured surface, wherein said figure is coupled to said contoured surface by an element that engages said groove and moves freely along said groove.

12. The device according to claim 7, wherein said contoured surface is disposed above said reservoir and drain holes are formed in said contoured surface to enable said stream of water to flow into said reservoir.

13. A method of creating a continuous display of a breaking wave, comprising:
providing a contoured surface having a concave section; and
advancing a stream of water into said concave section in a first direction, wherein said stream of water is turned upwardly and then opposite said first direction by said concave section, therein causing said stream of water to create a continuously breaking wave for as long as said stream of water endures.

14. The method according to claim 13, further including the step of floating a figure upon said breaking wave.

15. The method according to claim 13, wherein said step of providing a contoured surface includes providing a tabletop display having a contoured surface supported above a defined reservoir.

16. The method according to claim 15, wherein said step of advancing a stream of water includes pumping water from said reservoir onto said contoured surface.

17. The method according to claim 14, further including the step of confining said figure within a predetermined range of movement.
